(19) United States
(12) Patent Application Publication
(10) Pub. No.: US 2026/0155557 A1
(43) Pub. Date: Jun. 4, 2026

(54) Carrier with Compact Radiofrequency Identification Antenna for Mobile Computing Devices

(71) Applicant: Zebra Technologies Corporation, Lincolnshire, IL (US)

(72) Inventors: Ahmed B. Numan, Toronto (CA); Michele B. Feinstein, Oceanside, NY (US); Nicolas F. Casazzone, Dix Hills, NY (US)

(21) Appl. No.: 18/968,937

(22) Filed: Dec. 4, 2024

(51) Int. Cl. H01Q 1/24; H01Q 1/22; H01Q 9/04

(52) U.S. Cl. CPC H01Q 1/243; H01Q 1/2208; H01Q 9/0421; H01Q 9/0464

(57) ABSTRACT

A computing device comprises: a housing defining an interior of the computing device; an antenna carrier disposed in the interior, the antenna carrier including: a antenna carrier body defining an antenna mounting surface, the antenna carrier body having a first dielectric constant; a dielectric member attached to the antenna carrier body, the dielectric member having a second dielectric constant; and a patch antenna supported on the antenna mounting surface, the patch antenna including: (i) an outer annular opening between an outer portion of the patch antenna and an intermediate portion of the patch antenna; (ii) an outer short electrically connecting the outer portion with the intermediate portion across the outer annular opening; (iii) an inner annular opening between the intermediate portion and an inner portion of the patch antenna; and (iv) an inner short electrically connecting the intermediate portion with the inner portion across the inner annular opening.

### BACKGROUND

Mobile computing devices may include antennas for a variety of wireless communication technologies. The number and configuration of such antennas may increase the cost and complexity associated with assembling such devices.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 is a diagram illustrating a computing device.

FIG. 2 is a diagram illustrating a partially exploded view of the computing device of FIG. 1.

FIG. 3 is a diagram illustrating an antenna carrier of the computing device of FIG. 2.

FIG. 4 is a diagram illustrating an antenna of the carrier of FIG. 3.

FIG. 5 is a diagram illustrating an exploded view of the carrier of FIG. 3.

FIG. 6 is a diagram illustrating an exploded view of another antenna carrier.

FIG. 7 is a diagram illustrating a forward wall of the carrier of FIG. 6.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a computing device, comprising: a housing defining an interior of the computing device; an antenna carrier disposed in the interior, the antenna carrier including: a antenna carrier body defining an antenna mounting surface, the antenna carrier body having a first dielectric constant; a dielectric member attached to the antenna carrier body, the dielectric member having a second dielectric constant; and a patch antenna supported on the antenna mounting surface, the patch antenna including: (i) an outer annular opening between an outer portion of the patch antenna and an intermediate portion of the patch antenna; (ii) an outer short electrically connecting the outer portion with the intermediate portion across the outer annular opening; (iii) an inner annular opening between the intermediate portion and an inner portion of the patch antenna; and (iv) an inner short electrically connecting the intermediate portion with the inner portion across the inner annular opening.

Additional examples disclosed herein are directed to an antenna carrier for a computing device, the antenna carrier including: a carrier body defining a first antenna mounting surface and a second antenna mounting surface; a radiofrequency identification (RFID) antenna supported on the first antenna mounting surface, the RFID antenna including a complementary split-ring resonator; and a wireless wide-area network (WWAN) antenna supported on the second antenna mounting surface.

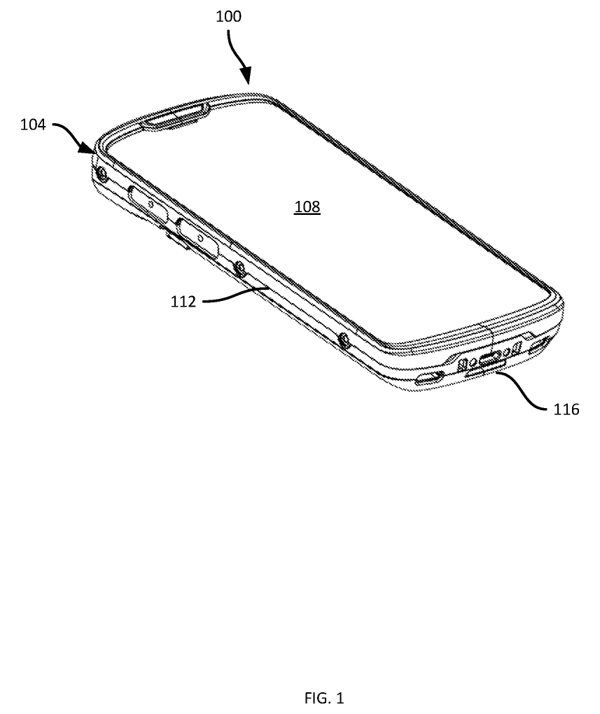

FIG. 1 illustrates a computing device 100 (also referred to herein as the device 100), such as a handheld computer or a smartphone. The device 100 can, in other examples, include any of a wide variety of other computing devices, such as a barcode scanner, a tablet computer, or the like. The computing device 100 includes a housing 104 supporting various other components of the device 100, including a display 108, e.g., integrated with a touch screen. The housing 104 and the display 108 can cooperate to define an interior of the device 100, containing those components. The housing 104 can include, for example, a side wall 112 and an opposing side wall (not visible in FIG. 1), as well as a bottom wall 116 and an opposing top wall (not visible in FIG. 1), together forming a boundary around the display 108. The housing 104 can further include a rear wall opposite the display 108.

The device 100 includes at least one wireless communications interface supported within the housing 104. The wireless communications interface can include one or more antennas, as well as suitable control hardware and firmware for transmitting and receiving data via the antennas. The device 100 can include a plurality of antennas, e.g., permitting the device to communicate with other devices (e.g., other computing devices, radiofrequency (RF) tags, and the like) via a plurality of communication standards. For example, the device 100 may include a set of antennas enabling communications over wireless wide-area networks (WWANs) according to the 5G standard, for example. The device 100 can also, in addition to the WWAN antennas(s), include one or more antennas enabling communications over wireless local area networks (WLANs), e.g., WiFi networks based on the 802.11 family of standards. The device 100 can include further antennas and associated transceivers and other hardware elements for use in reading and/or writing data to or from RF identification (RFID) tags, exchanging data via near-field communication (NFC), or the like.

As will be apparent to those skilled in the art, physical space in the device interior to accommodate the above antennas may be limited. Further, the antennas may be relatively fragile components (e.g., compared to circuit boards and other assemblies contained in the device’s interior) of various sizes. Due to the limited space available within the device 100 as noted above, miniaturizing antennas may be appealing, although such miniaturization may complicate assembly and/or reduce antenna performance. Assembly of the device 100 may therefore be rendered more complex by the antennas, e.g., if each antenna is installed and connected to one or more controllers, circuit boards, or the like, separately from the other antennas.

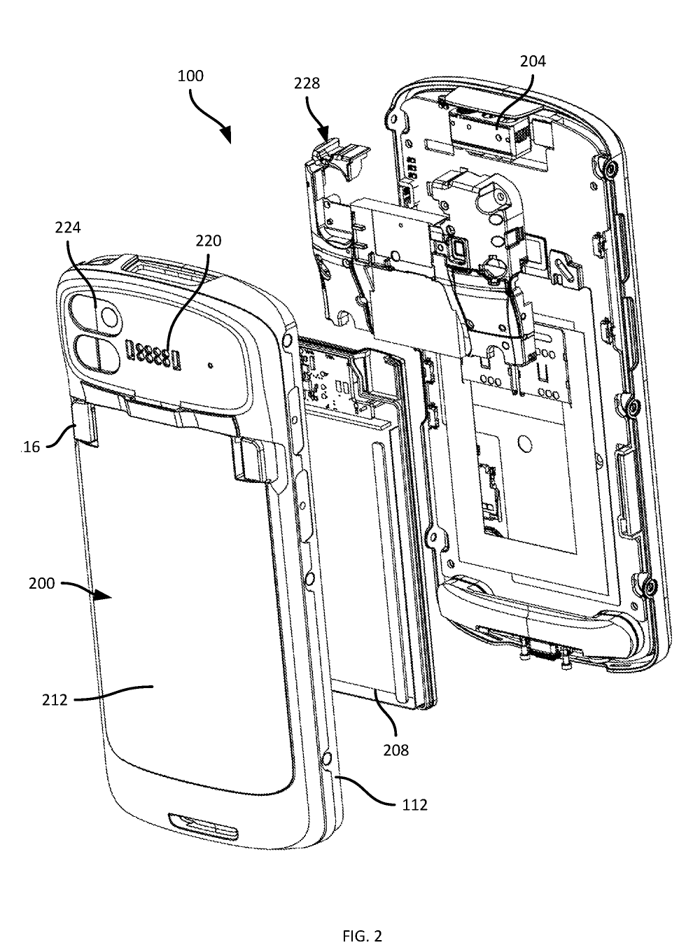

FIG. 2 is a partially exploded view of the device 100 from the rear, showing a rear wall 200 opposite the display 108 from FIG. 1. Among the internal components of the device 100 are a scan module 204, e.g., including an image sensor and associated control hardware configured to capture images and detect and decode barcodes or other indicia therein. The device 100 can also include a battery module 208, along with various circuit boards, connectors, and the like, configured to electrically interconnect controller(s), input/output devices (e.g., the display 108, a touch panel, buttons disposed on the sides of the device 100), and the like of the device 100. The rear wall 200 can include a removable cover 212 (e.g., removable via latches 216) to expose the battery 208, e.g., for replacement of the battery 208.

The device 100 can also include an input/output interface 220, e.g., including a set of electrical contacts, pogo pins, or the like, permitting the device 100 to establish communications with one or more accessories, peripheral devices, or the like. The device 100 can also receive power from an external source via the interface 220, and/or supply power to an accessory or peripheral via the interface 220. Examples of such devices include a sled or mount for wearing the device 100 on an arm or wrist of an operator, a dock or other accessory configured to provide power and/or additional communication capabilities to the device 100, or the like. The device 100 can also include sensor modules in addition to the scan module 204, such as a camera 224 with a field of view extending substantially perpendicular to the rear wall 200 of the device 100.

The device 100 also includes, in the embodiment shown in FIG. 2, an antenna carrier 228, also referred to herein as a carrier 228. The carrier 228 provides a platform for the fabrication and/or installation of one or more antennas (the antennas are omitted from FIG. 2 for clarity, but are illustrated in subsequent figures). Once the antenna(s) are fabricated or installed onto the carrier 228, the carrier 228 can be installed into the interior of the device 100, which may simplify antenna installation compared to the installation of individual antennas directly into the device interior.

Certain wireless communication technologies, such as RFID, may operate at frequencies involving the use of antennas that are difficult to physically accommodate on the carrier 228. The relatively low operating frequencies of such technologies (e.g., hundreds of megahertz, relative to multi-gigahertz frequencies employed by other communication technologies) and the correspondingly large wavelengths of such technologies may necessitate physically larger antennas than, for example, certain WLAN or WWAN technologies. Some RFID antennas may therefore be difficult to install into the device 100 (e.g., during assembly of the device 100). Furthermore, fitting RFID antennas onto the main antenna carrier 228 may prove to be an additional challenge due to space limitations, so an additional carrier may be necessary, which may increase the cost and/or complexity of the device assembly.

As discussed below, the carrier 228, or another suitable carrier than can be installed in the device along with the carrier 228, includes an antenna that supports operating frequencies suitable for RFID communications (e.g., frequencies between about 900 MHz and about 930 MHz, and/or frequencies between about 865 MHz and about 870 MHz). The configuration of the antenna, and of the carrier 228, may therefore simplify assembly of the device 100 by permitting an additional antenna (e.g., the RFID antenna) to be installed on the carrier 228 rather than directly into the device 100, due to its reduced size in comparison with other RFID antennas.

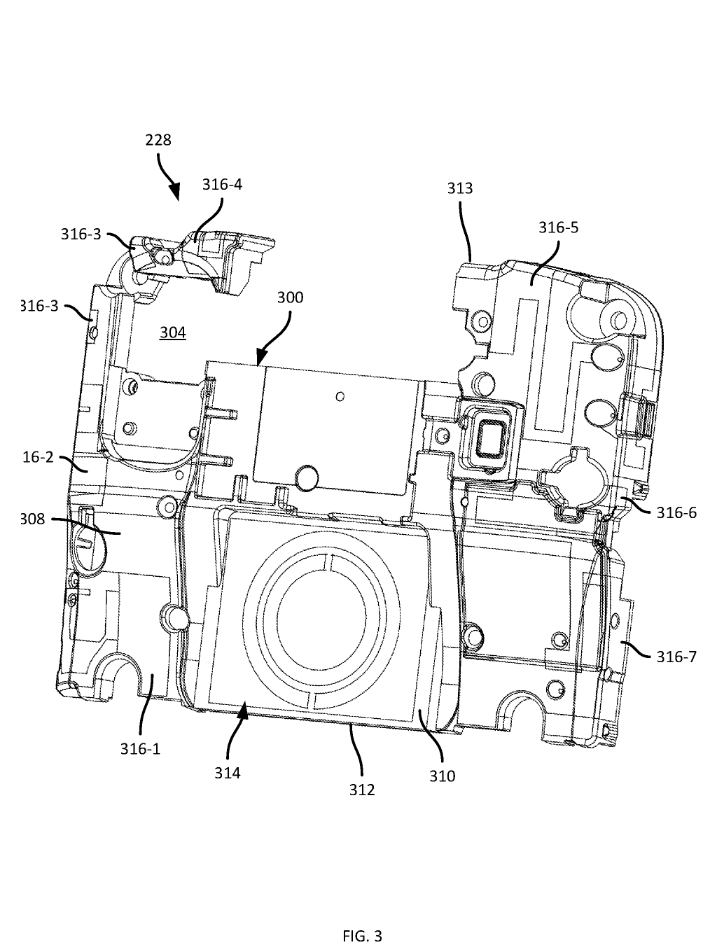

Turning to FIG. 3, the carrier 228 includes a carrier body 300, e.g., injection-molded or otherwise formed of a single piece of material, such as a suitable plastic. In other examples, the body 300 may be fabricated from multiple distinct pieces. The body 300 may have a relative permittivity, also referred to as a dielectric constant, of about 3, in some examples. The body 300 can include cutouts such as a cutout 304 to accommodate the camera 224, for example. The body includes a rear wall 308, shown in FIG. 3, and a forward wall opposite the rear wall 308 (facing away from the view of FIG. 3). The rear wall 308, in other words, faces away from the display 108, and the forward wall faces towards the display 108, when the carrier 228 is installed in the device 100.

The carrier 228 also includes a mounting surface 310, e.g., on the rear wall 308 in this example. The mounting surface 310 is, in this example, a substantially planar surface centered along the width (left to right in FIG. 3) of the carrier 228. The mounting surface 310 is disposed adjacent to a lower end 312 of the carrier 228, opposite from an upper end 313 of the carrier 228. As will be apparent, the position of the mounting surface 310 on the carrier 228 places the mounting surface 310 near an upper end of the cover 212 shown in FIG. 2.

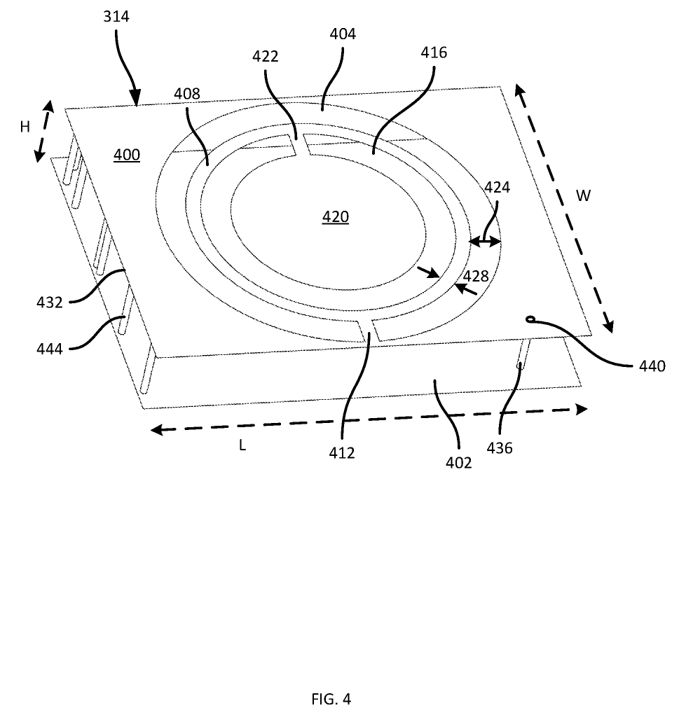

The carrier 228 includes an antenna 314 including a first portion supported on the mounting surface 310 and a ground plane (not visible in FIG. 3) on an opposite side of the carrier 228 from the portion shown in FIG. 3. The antenna 314, structural features of which are discussed further below in connection with FIG. 4, can have a resonant frequency suitable for use in RFID communications (e.g., about 900 MHz to about 930 MHz, and/or about 865 MHz to about 870 MHz). The carrier 228 can also include a plurality of additional mounting surfaces, each supporting an additional antenna. The carrier 228 can also include, in the illustrated example, a plurality of additional antennas 316-1, 316-2, 316-3, 316-4, 316-5, 316-6, and 316-7 (collectively referred to as the antennas 316, and generically as an antenna 316). The antennas 316 can have frequencies suitable for use with cellular communication standards (e.g., 5G), WiFi standards, Global Positioning System (GPS) signals, and the like. The antenna 314 and the additional antennas 316 can be fabricated via laser direct structuring (LDS) or other suitable fabrication methods, in which the metal or other conductive material forming the antennas 314 and 316 is deposited directly on the dielectric material of the carrier body 300.

Turning to FIG. 4, the antenna 314 is shown in isolation. The antenna 314 is a patch antenna including a complementary split-ring resonator (CSRR) structure, and provides a dual linear polarized (e.g., horizontal and vertical polarization) radiation, directed through and substantially perpendicular to the rear wall 200 of the device 100. In particular, the antenna 314 includes an outer portion 400 defining a perimeter of the antenna 314, with a length “L” and a width “W”. The antenna also includes a ground plane 402 spaced apart from the patch defining the outer portion 400. The dimensions L and W are selected to provide, due in part to the CSRR structure, a resonant frequency suitable for use in RFID communications. Example dimensions of the antenna 314 are discussed further below. The thickness of the metal layer defining the outer portion 400 can be comparatively small (e.g., smaller than 1 mm) relative to L and W. The antenna 314 can also have a height “H”, defined by the distance between the outer portion 400 and the ground plane 402. The height of the antenna 314 can therefore be set, e.g., by varying the thickness of the carrier 228.

The antenna 314 further includes an outer annular opening 404, extending through the patch, between the outer portion 400 and an intermediate portion 408. The antenna 314 further includes an outer short 412 electrically connecting the outer portion 400 with the intermediate portion 408 across the outer annular opening 404. The outer short 412, in other words, splits or breaks the outer annular opening 404. The antenna 314 further includes an inner annular opening 416 between the intermediate portion 408 and an inner portion 420 of the antenna 314. The annular openings 404 and 416 are concentric in this example. Although the annular openings 404 and 416 are circular in the illustrated example, in other examples the annular openings 404 and 416 can be oval-shaped, rectangular, or the like. The antenna 314 also includes an inner short 422 electrically connecting the intermediate portion 408 with the inner portion 420 across the inner annular opening 416. The shorts 412 and 422, as seen in FIG. 4, are substantially opposite from one another (e.g., at an angle of about 180 degrees) on their respective annular openings. In other embodiments, the shorts 412 and 422 can be disposed at other angles relative to the length and width of the outer portion 400, but remain at an angle of about 180 degrees relative to each other in such embodiments.

The intermediate portion 408, as will be apparent, is substantially annular as a result of the annular openings 404 and 416 being concentric. The dimensions of the annular openings 404 and 416 can be selected based on either or both of manufacturing tolerances for the deposition technology used to manufacture the antenna 314. For example, the annular openings 404 and 416 can have widths 424 of about 1.8 mm, and the intermediate portion 408 can have a width 428 of about 0.8 mm. A wide variety of other dimensions can also be implemented, however, e.g., to tune the resonant frequency of the antenna 314. In some examples, e.g., if the manufacturing technology used can provide smaller elements, the intermediate portion 408 may have a smaller width 428. In further examples, the antenna 314 can include one or more additional elements concentric with the intermediate portion 408, e.g., connected with adjacent portions by additional shorts and defined by additional annular openings.

The inner portion 420, as shown in FIG. 4, is substantially centered on the patch of the antenna 314. In other examples, however, the CSRR structure (that is, the annular openings 404 and 416, and the intermediate portion 408 and the inner portion 420) can be shifted towards a side of the antenna 314, such as a first side 432.

The carrier 228 includes a feed 436, e.g., extending from the forward wall of the carrier 228 through the carrier body 300 to a feed point 440 on the outer portion 400. The carrier 228 can also include one or more shorting pins 444, e.g., adjacent to the side 432, connected to the ground plane 402. The shorting pins 444, which can be disposed at the side of the antenna 314 furthest from the feed point 440 as in the illustrated example, may increase the resonant wavelength of the antenna 314 for a given set of dimensions L, W and H. For example, for a given length L, the shorting pins 444 in cooperation with a ground plane may substantially double the resonant wavelength of the antenna 314. In other examples, the feed point 440 may be placed closer to the shorting pins 444, however.

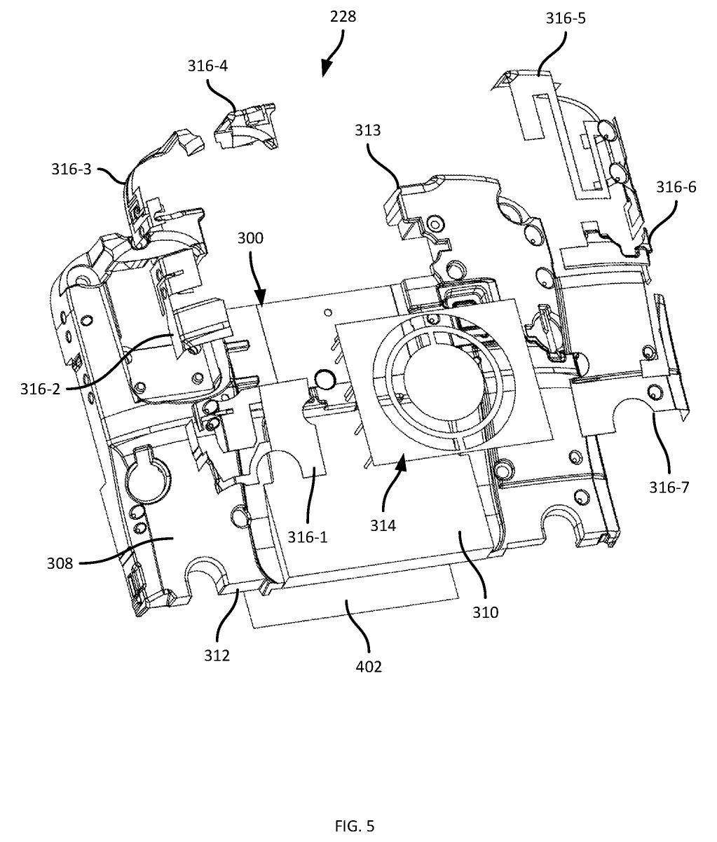

Turning to FIG. 5, an exploded view of the carrier 228 is shown, with the antennas 314 and 316 displaced from their respective mounting surfaces (including the mounting surface 310 for the antenna 314) on the body 300. The body 300 can also include apertures extending therethrough from the mounting surface to the forward wall of the body 300, to permit passage of the shorting pins 444 and the feed 436. Also shown in FIG. 5, the carrier 228 supports the ground plane 402, e.g., supported on the forward wall of the body 300 opposite the mounting surface 310. The ground plane 402 can have dimensions substantially equal to the dimensions L and W of the antenna 314. The shorting pins 444 extend to the ground plane 402, and the feed 436 can extend through the ground plane 402, e.g., to connect the antenna 314 with an RFID transceiver of the device 100 or other suitable hardware elements housed in the device interior.

The dimensions L and W of the antenna 314, in the embodiment shown in FIG. 5, can be about 30 mm and about 24 mm, respectively. The length of 30 mm is, for example, about one sixth of the resonant wavelength of the antenna 314, e.g., about 188 mm, corresponding to a resonant frequency of about 920 MHz when the antenna 314 is mounted on the body 300 with a dielectric constant of about 3. As will be apparent, the shorting pins 444 to the ground plane 402, along with the CSRR structure, may permit the antenna 314 to operate at a significantly larger resonant wavelength than a patch antenna lacking those features, while providing dual polarization to the radiated signal. Such a patch antenna would necessitate a length of about 94 mm, which may be difficult to accommodate on the carrier 228.

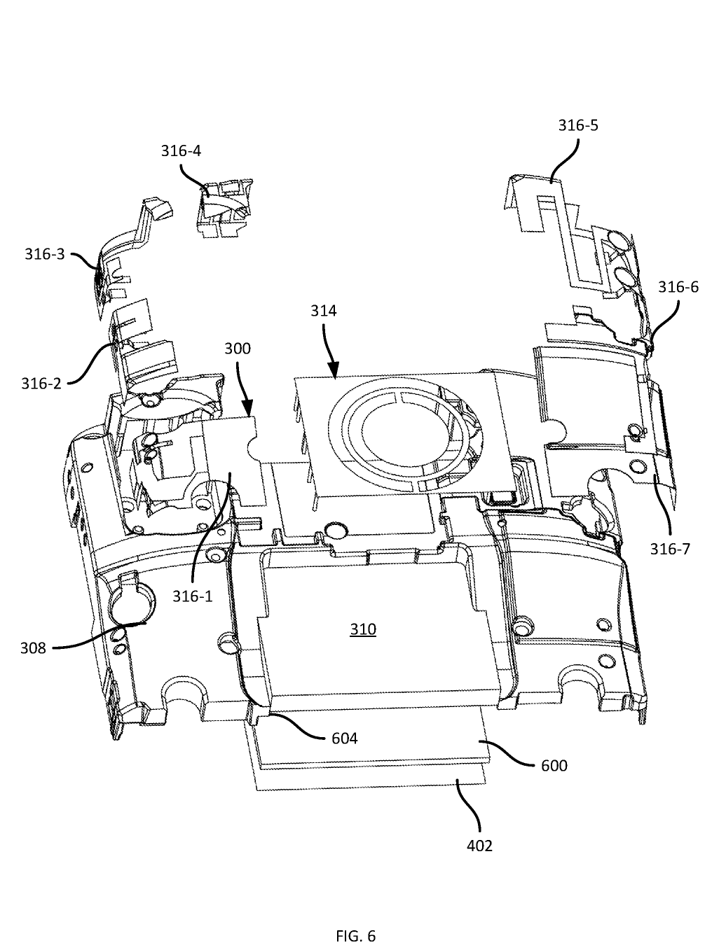

Turning to FIG. 6, another embodiment of the carrier 228 is shown, including a dielectric member 600 on the forward wall of the body 300, opposite the mounting surface 310. The dielectric member 600 is positioned away from the direction of radiation of the antenna 314, in and in between the ground plane 402 and the body 300. The dielectric member 600 is made of a material (e.g., Preperm™ L1000HF) with a higher dielectric constant than the material of the body 300. For example, the dielectric member 600 can have a dielectric constant of about 10. The dielectric member 600 has a length and width substantially equal to those of the ground plane 402 of the antenna 314. The dielectric member 600 has a thickness of about 2 mm, in this example, and can include pass-throughs or other apertures for the feed 436 and shorting pins 444. In other examples, the feed 436 and shorting pins 444 may be routed around the sides of the dielectric member 600, and such pass-throughs may be omitted. Various other dimensions can also be implemented for the dielectric member 600 in other examples.

The dimensions L and W of the antenna 314, in the embodiment shown in FIG. 6, can be about 26 mm and about 20 mm, respectively. The length of 26 mm, as will be apparent to those skilled in the art, is less than one sixth of the resonant wavelength of the antenna 314, e.g., about 188 mm, corresponding to a resonant frequency of about 920 MHz. The provision of the dielectric member 600, in other words, enables a further reduction in size of the antenna 314 while providing similar performance characteristics.

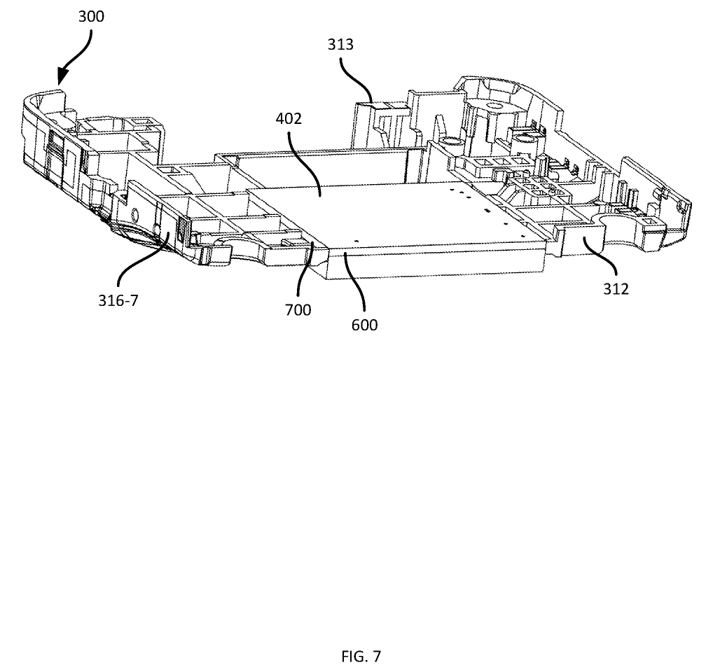

The dielectric member 600 can be accommodated on the carrier 228 with little or no change to the outer envelope of the carrier 228 by, for example, modifying the carrier 228 relative to the design of FIG. 5 with a cutout 604, also shown in FIG. 7. FIG. 7 shows the carrier 228 from the front, illustrating that the ground plane 402, which is disposed on the dielectric member 600, is substantially flush with a surrounding portion of a forward wall 700 of the carrier body 300.

Providing the dielectric member 600 as a discrete part, rather than manufacturing the entire carrier 228 from the material of the dielectric member 600, may improve mechanical performance of the carrier 228, while mitigating increased manufacturing complexity for the carrier 228. For example, the LDS technology used to deposit the antennas 314 and 316 requires no adaptation when the antennas 314 and 316 continue to be placed on the lower-dielectric material of the body 300. Further, the carrier 228 can be manufactured by, for example, overmolding the dielectric member 600 with the carrier body 300. The dielectric member 600 may have mechanical properties that are less suited to use for the entire carrier body 300 (e.g., the dielectric member 600 may be more brittle than the carrier body 300). Therefore, embedding a comparatively smaller portion of material with such properties in the carrier body 300 may provide improved antenna performance without significantly degrading mechanical performance.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms "comprises," "comprising," “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises …a”, “has …a”, “includes …a”, “contains …a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

Certain expressions may be employed herein to list combinations of elements. Examples of such expressions include: “at least one of A, B, and C”; “one or more of A, B, and C”; “at least one of A, B, or C”; “one or more of A, B, or C”. Unless expressly indicated otherwise, the above expressions encompass any combination of A and/or B and/or C.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A computing device, comprising:
a housing defining an interior of the computing device;
an antenna carrier disposed in the interior, the antenna carrier including:
a antenna carrier body defining an antenna mounting surface, the antenna carrier body having a first dielectric constant;
a dielectric member attached to the antenna carrier body, the dielectric member having a second dielectric constant; and
a patch antenna supported on the antenna mounting surface, the patch antenna including:
(i) an outer annular opening between an outer portion of the patch antenna and an intermediate portion of the patch antenna;
(ii) an outer short electrically connecting the outer portion with the intermediate portion across the outer annular opening;
(iii) an inner annular opening between the intermediate portion and an inner portion of the patch antenna; and
(iv) an inner short electrically connecting the intermediate portion with the inner portion across the inner annular opening.

2. The computing device of claim 1, wherein the outer annular opening and the inner annular opening are concentric.

3. The computing device of claim 1, wherein the patch antenna is a radiofrequency identification (RFID) antenna having a resonant frequency between about 865 MHz and about 870 MHz, or between about 900 MHz and about 930 MHz.

4. The computing device of claim 1, wherein the outer portion of the patch antenna has a rectangular perimeter; and wherein a first dimension of the perimeter is smaller than one quarter of a resonant wavelength of the patch antenna.

5. The computing device of claim 1, wherein the outer annular opening, the outer short, the inner annular opening, and the inner short define a complementary split-ring resonator (CSRR).

6. The computing device of claim 1, wherein the antenna carrier body includes a forward wall facing towards a display of the computing device, and a rear wall facing away from the display; and wherein the antenna mounting surface is on the rear wall.

7. The computing device of claim 6, wherein the antenna carrier further comprises:
a ground plane supported on the forward wall opposite the antenna mounting surface; and
a shorting pin extending through the antenna carrier body from the patch antenna to the ground plane; wherein the shorting pin is adjacent to a first side of the patch antenna.

8. The computing device of claim 6, further comprising: a feed connection extending from the forward wall through the antenna carrier body to the patch antenna.

9. The computing device of claim 6, wherein the first dielectric constant of the antenna carrier body is smaller than the second dielectric constant of the dielectric member.

10. The computing device of claim 1, wherein the antenna carrier defines a further mounting surface; the antenna carrier further comprising: a further antenna supported on the further mounting surface.

11. An antenna carrier for a computing device, the antenna carrier including:
a carrier body defining a first antenna mounting surface and a second antenna mounting surface;
a radiofrequency identification (RFID) antenna supported on the first antenna mounting surface, the RFID antenna including a complementary split-ring resonator; and
a further antenna supported on the second antenna mounting surface.

12. The antenna carrier of claim 11, wherein the RFID antenna includes:
a patch having an outer portion, an intermediate portion, and an inner portion;
an outer annular opening between the outer portion and the intermediate portion;
an outer short electrically connecting the outer portion with the intermediate portion across the outer annular opening;
an inner annular opening between the intermediate portion and the inner portion; and
an inner short electrically connecting the intermediate portion with the inner portion across the inner annular opening.

13. The antenna carrier of claim 12, wherein a first dimension of the patch is smaller than one quarter of a resonant wavelength of the RFID antenna.

14. The antenna carrier of claim 13, wherein the first dimension is smaller than one fifth of the resonant wavelength.

15. The antenna carrier of claim 11, wherein the carrier body includes a forward wall facing towards a first side of the computing device, and a rear wall facing away from the first side; and wherein the antenna mounting surface is on the rear wall.

16. The antenna carrier of claim 15, wherein the antenna carrier further comprises: a ground plane supported on the forward wall opposite the first antenna mounting surface.

17. The antenna carrier of claim 16, further comprising:
a shorting pin extending through the carrier body from the RFID antenna to the ground plane;
wherein the shorting pin is adjacent to a first side of the RFID antenna.

18. The antenna carrier of claim 15, further comprising: a feed connection extending from the forward wall through the carrier body to the RFID antenna.

19. The antenna carrier of claim 15, wherein the carrier body has a first dielectric constant adjacent to the first antenna mounting surface, and a second dielectric constant adjacent to the second antenna mounting surface.

20. The antenna carrier of claim 19, wherein the first dielectric constant is greater than the second dielectric constant.
